(19) United States
(12) Patent Application Publication
(10) Pub. No.: US 2026/0133103 A1
(43) Pub. Date: May 14, 2026

(54) STIFFNESS MEASUREMENT DEVICE

(71) Applicant: Konica Minolta, Inc., Tokyo (JP)

(72) Inventor: Bowen YANG, Tokyo (JP)

(21) Appl. No.: 19/377,162

(22) Filed: Nov. 3, 2025

(30) Foreign Application Priority Data
Nov. 8, 2024 (JP) 2024-195892

(51) Int. Cl. G01N 3/08; G01N 3/02

(52) U.S. Cl. CPC G01N 3/08; G01N 3/02; G01N 2203/0262

(57) ABSTRACT

A stiffness measurement device includes: a holder that is capable of stopping a sheet material being conveyed along a conveyance direction and holding the sheet material; a pressing unit that is disposed upstream of the holder in the conveyance direction and that presses the sheet material held by the holder from one main surface side of the sheet material; a stiffness obtainer that measures reaction force of the sheet pressed by the pressing unit to obtain stiffness of the sheet; and a guide that is disposed upstream of the holder in the conveyance direction and guides the sheet material to the holder. The guide includes a movable guide. The movable guide is disposed at a position where the movable guide faces the pressing unit with a conveyance route of the sheet material in-between and is retractable from the position.

### CROSS REFERENCE TO RELATED APPLICATIONS

The present invention claims priority under 35 U.S.C. § 119 to Japanese Patent Application No. 2024-195892 filed on Nov. 8, 2024, the entire contents of which being incorporated herein by reference.

### BACKGROUND OF THE INVENTION

### Technical Field

The present disclosure relates to a stiffness measurement device that measures stiffness of a sheet.

### Description of Related Art

A known image forming system forms an image on a sheet (sheet material), detects the stiffness of the sheet, and determines various control parameters.

For example, in the technique described in Japanese Unexamined Patent Publication No. 2024-019982, the stiffness of the sheet is measured by holding the sheet in a stationary state, pressing the edge of the sheet, and measuring the reaction force of the sheet.

### SUMMARY OF THE INVENTION

In order to avoid interference between a guide plate that guides the sheet and a pressing unit that presses the sheet, a gap is needed in part of the guide plate that faces the pressing unit, for example. However, the gap in the guide plate may catch the sheet being conveyed, and sheet conveyance performance may be decreased.

The present disclosure has been made in view of the above circumstances, and an object of the present disclosure is to prevent a decrease in sheet conveyance performance and properly measure the stiffness of a sheet.

To achieve at least one of the abovementioned objects, according to an aspect of the present disclosure, a stiffness measurement device includes: a holder that is capable of stopping a sheet material being conveyed along a conveyance direction and holding the sheet material; a pressing unit that is disposed upstream of the holder in the conveyance direction and that presses the sheet material held by the holder from one main surface side of the sheet material; a stiffness obtainer that measures reaction force of the sheet pressed by the pressing unit to obtain stiffness of the sheet; and a guide that is disposed upstream of the holder in the conveyance direction and guides the sheet material to the holder, wherein: the guide includes a movable guide, and the movable guide is disposed at a position where the movable guide faces the pressing unit with a conveyance route of the sheet material in-between and is retractable from the position.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 illustrates an image forming system according to an embodiment;

FIG. 2 schematically illustrates a configuration of a stiffness measurement device according to the embodiment;

FIG. 3 illustrates a modification example of a first fixed guide in the embodiment;

FIG. 4 is a perspective view of a modification example showing how a movable guide is moved according to the embodiment;

FIG. 5 is a block diagram showing a schematic control configuration of the stiffness measurement device according to the embodiment;

FIG. 6 is a flowchart showing the flow of operations of the stiffness measurement device according to the embodiment;

FIG. 7 is a diagram for explaining operations of the stiffness measurement device according to the embodiment;

FIG. 8 is a diagram for explaining operations of the stiffness measurement device according to the embodiment;

FIG. 9 is a diagram for explaining operations of the stiffness measurement device according to the embodiment; and

FIG. 10 illustrates a modification example of the first fixed guide according to the embodiment.

### DETAILED DESCRIPTION

Hereinafter, one or more embodiments of the present invention will be described with reference to the drawings. However, the scope of the invention is not limited to the disclosed embodiments.

### [Configuration of Image Forming System]

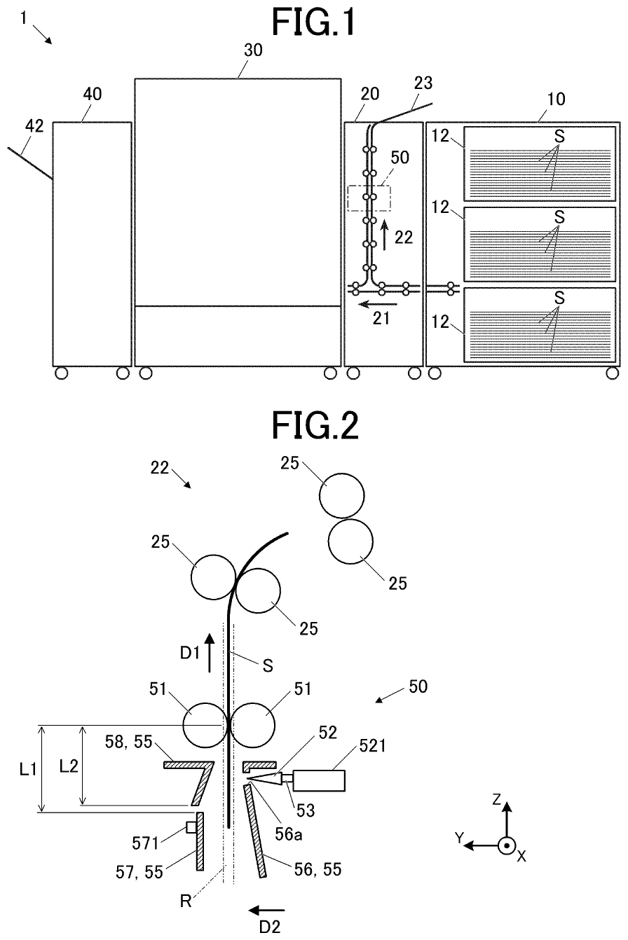

FIG. 1 illustrates an image forming system 1 according to the present embodiment.

As illustrated in FIG. 1, the image forming system 1 includes a sheet feed device 10, a sheet conveyance device 20, an image forming apparatus 30, and a post-processing device 40.

The sheet feed device 10 includes a plurality of sheet feed trays 12 on which various types of sheets S classified by basis weight, size, and so forth are loaded. The sheet feed device 10 supplies predetermined sheets S one by one to the sheet conveyance device 20, based on a print job from a non-illustrated controller.

The sheet S is a recording medium on which an image is formed. The sheet S is an example of a sheet material according to the present disclosure. The material and so forth of the sheet S are not particularly limited as long as the stiffness of the sheet S is measurable.

The sheet conveyance device 20 is disposed downstream of the sheet feed device 10 and upstream of the image forming apparatus 30 in the conveyance direction. The sheet conveyance device 20 includes a first conveyance route 21 that conveys the sheet S conveyed from the sheet feed device 10 to the image forming apparatus 30 and a second conveyance route 22 that branches from the first conveyance route 21. To obtain and register information on the sheet S, the sheet S is guided from the first conveyance route 21 to the second conveyance route 22 and conveyed to a second ejection port 23, for example.

The second conveyance route 22 is provided with a stiffness measurement device 50 that obtains the stiffness of the sheet S. As described later, the stiffness measurement device 50 measures the stiffness of the sheet S that is temporarily stopped in the middle of the second conveyance route 22. The stiffness of the sheet S is an index of resistance of the bent sheet S. The stiffness can be expressed by various physical quantities.

The stiffness measurement device 50 will be described in detail later.

The image forming apparatus 30 forms images by an electrophotographic process. The image forming apparatus 30 forms (transfers and prints) an image read from a document onto the sheet S conveyed from the sheet feed device 10. The image forming apparatus 30 receives job data that includes image data in a page description language (PDL) format and setting information from an external client terminal over the network and based on the job data, forms an image on the sheet S. The client terminal is, for example, a PC, a tablet, or a smartphone. The image forming apparatus 30 conveys the sheet S on which the image has been formed to the post-processing device 40.

The post-processing device 40 performs predetermined post-processing on the sheet S on which the image has been formed by the image forming apparatus 30, based on a post-processing job from a non-illustrated controller. Examples of the post-processing include perforation processing, folding processing, foil stamping, binding, cutting processing, stapling, gluing, and binding. The post-processing device 40 ejects the post-processed sheet S to the first ejection port 42.

### [Configuration of Stiffness Measurement Device]

FIG. 2 schematically illustrates a configuration of the stiffness measurement device 50.

As illustrated in FIG. 2, the stiffness measurement device 50 is disposed at the second conveyance route 22 of the sheet conveyance device 20. In the second conveyance route 22, the sheet S is conveyed from the lower side to the upper side by the plurality of conveyance rollers 25. The stiffness measurement device 50 measures the stiffness of the sheet S at a position of the second conveyance route 22 where the conveyance direction D1 of the sheet S is upward in the vertical direction.

Hereinafter, the vertical direction along the conveyance direction D1 is referred to as the Z direction. Further, the direction perpendicular to the recording surface (main surface) of the sheet S conveyed in the conveyance direction D1 is referred to as the Y direction, and the width direction of the sheet S perpendicular to the Z and Y directions is referred to as the X direction.

Specifically, the stiffness measurement device 50 includes a pair of holding rollers 51 (holder), a pressing unit 52, a reaction force measurer 53, and guides 55.

The pair of holding rollers 51 is a holder that can stop and hold the sheet S conveyed along the conveyance direction D1. Specifically, the paired holding rollers 51 are arranged next to each other in the Y direction and biased in directions toward each other, thereby sandwiching and holding the sheet S with a predetermined holding force, for example. The pair of holding rollers 51 holds the sheet S in a state where the main surface of the sheet S is substantially perpendicular to the Y direction. Although the configuration of the pair of holding rollers 51 is not particularly limited, it is preferable that the pair of holding rollers 51 also serve as conveyance rollers that can be driven.

The pressing unit 52 presses an edge portion of the sheet S to measure the stiffness. Specifically, the pressing unit 52 is disposed upstream of (at the lower side of) the holding rollers 51 in the conveyance direction D1 and at one side (right side in FIG. 2) of a conveyance route R in the Y direction. Herein, the conveyance route R refers to the route of the sheet S along the Z direction in the stiffness measurement device 50. The pressing unit 52 has a blade shape elongated in the X direction so that the pressing unit 52 can contact the entire width of the sheet S. The blade-shaped pressing unit 52 has a pointed tip on the other side in the Y direction (the left side in FIG. 2). To measure stiffness, the pressing unit 52 presses the lower end portion of the sheet S held by the holding rollers 51 in a pressing direction D2 and bends the sheet S. The pressing direction D2 is from the one main surface side (the right side of FIG. 2) toward the other side in the Y direction.

The pressing unit 52 is supported by a movement mechanism 521 so as to be movable in the Y direction. The movement mechanism 521 includes, for example, a rack gear that is integrated with the pressing unit 52 and extends in the Y direction and a stepping motor that engages with the rack gear. The pressing unit 52 moves in the Y direction by the driving of the stepping motor. The configuration of the movement mechanism 521 is not particularly limited as long as the movement mechanism 521 can move the pressing unit 52 in the Y direction.

The reaction force measurer 53 measures the reaction force of the sheet S pressed by the pressing unit 52. The reaction force measurer 53 is, for example, a load cell (pressure sensor) disposed between the pressing unit 52 and the movement mechanism 521. The reaction force measurer 53 outputs the obtained value of the reaction force to the controller 60 (see FIG. 5). The stiffness obtainer according to the present disclosure includes the reaction force measurer 53 and the controller 60.

The guides 55 are disposed upstream of the holding rollers 51 in the conveyance direction D1 and guides the sheet S to the holding rollers 51. The guides 55 according to the present embodiment guide the sheet S such that the sheet S enters the holding rollers 51 along the vertical direction.

Specifically, the guides 55 include a first fixed guide 56, a second fixed guide 57, and a movable guide 58. The first fixed guide 56, the second fixed guide 57, and the movable guide 58 are plate-shaped, for example, and disposed to cover both sides of the conveyance route R in the Y direction.

The first fixed guide 56 is fixed at the upstream side of the holding rollers 51 in the conveyance direction D1 and at one side of the conveyance route R in the Y direction.

The first fixed guide 56 has, in its guide surface for guiding the sheet S, a through hole 56a that passes through the first fixed guide 56 in the Y direction. The through hole 56a has an elongated shape in the X direction so as to correspond to the shape of the pressing unit 52 (pressing surface) as viewed from the other side in the Y direction. In a normal state in which the pressing unit 52 does not press the sheet S, the pressing unit 52 is disposed at one side in the Y direction of the through hole 56a. In pressing the sheet S, the pressing unit 52 protrudes from the through hole 56a in the Y direction.

It is preferable that, in the normal state, the gap between the pressing unit 52 and the through hole 56a be as narrow as possible so that the gap does not catch the being-conveyed sheet S.

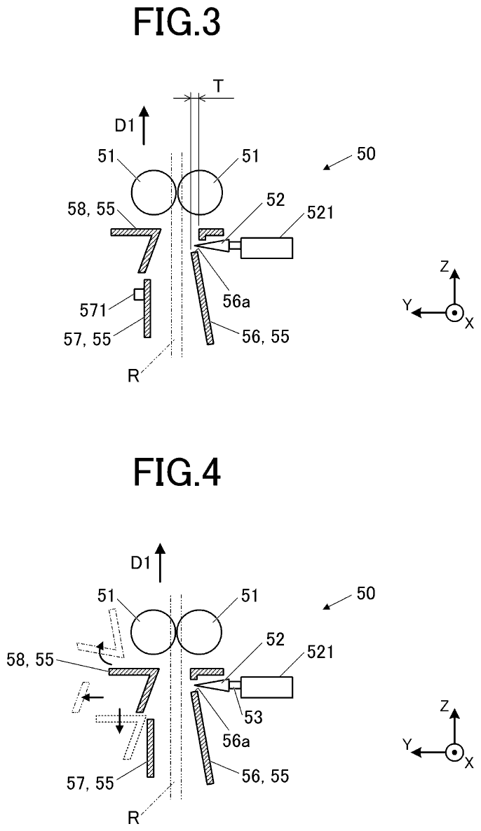

As shown in FIG. 3, opening ends of the through hole 56a may have a step T in the Y direction such that the downstream opening end in the conveyance direction D1 is farther from the conveyance route R in the Y direction than the upstream opening end. Thus, the being-conveyed sheet S can be prevented from entering the through hole 56a.

As shown in FIG. 2, the second fixed guide 57 is fixed at the upstream side of the holding rollers 51 in the conveyance direction D1 and at the other side of the conveyance route R in the Y direction. More specifically, the second fixed guide 57 is disposed to face the lower half part of the first fixed guide 56 with the conveyance route R in-between.

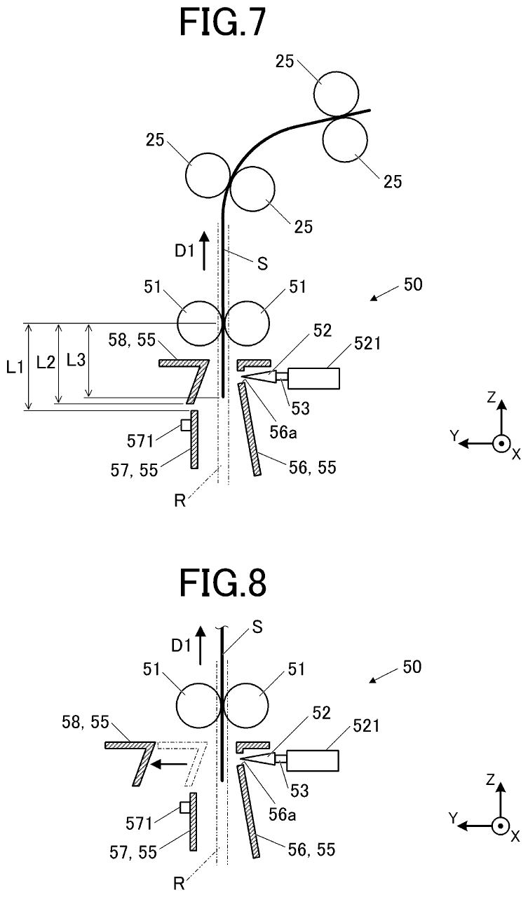

The upper end of the second fixed guide 57 is separate from the nip part of the holding rollers 51 by a distance L1 in the up-down direction. Therefore, in measuring the stiffness, the second fixed guide 57 is disposed upstream of the lower end (rear end) of the sheet S held by the holding rollers 51 in the conveyance direction D1 (see FIG. 7), as described later.

Further, a detection sensor 571 capable of detecting the position of the sheet S in the conveyance direction D1 is fixed to the second fixed guide 57. The detection sensor 571 is capable of detecting passing of the sheet S in the conveyance direction D1, namely detecting the lower end of the sheet S, and outputs the detection result to the controller 60. The detection sensor 571 may not be fixed to the second fixed guide 57 but may be fixed to the first fixed guide 56.

The movable guide 58 is disposed to face the upper half part of the first fixed guide 56 with the conveyance route R in-between and disposed at the upper side of the second fixed guide 57. The movable guide 58 in the present embodiment is movable in the Y direction by the driving of the drive motor 581 (see FIG. 5), for example. In the normal state, the movable guide 58 is disposed close to the conveyance route R to guide the sheet S, whereas in the stiffness measurement state, the movable guide 58 moves to the other side in the Y direction and is thereby separate from the conveyance route R, as described later.

The lower end of the movable guide 58 is separate from the nip part of the holding rollers 51 by a distance L2 (<L1) in the up-down direction. In measuring the stiffness, the lower end of the movable guide 58 is located at the upstream side in the conveyance direction D1 of the lower end of the sheet S held by the holding roller 51 (see FIG. 7), as described later.

The operation of the movable guide 58 is not particularly limited as long as the movable guide 58 can retract from the position where the movable guide 58 faces the pressing unit 52 with the conveyance route R in-between. For example, as shown in FIG. 4, the movable guide 58 may move in the Z direction (shown by a broken line) or may rotate to the other side in the Y direction (shown by an alternate long and short dash line) instead of moving in the Y direction. For another example, only a part of the movable guide 58 including the part facing the pressing unit 52 with the conveyance route R in-between may be moved (shown by a two-dot chain line).

FIG. 5 is a block diagram of a schematic control configuration of the stiffness measurement device 50.

As illustrated in FIG. 5, the stiffness measurement device 50 includes the controller 60. The controller 60 includes, for example, a central processing unit (CPU), a random access memory (RAM), and a read only memory (ROM) and controls operations of each component of the stiffness measurement device 50. Specifically, the controller 60 controls operations of the holding rollers 51, the movement mechanism 521, and the drive motor 581, based on the output of the sensor 571 and so forth, and obtains the stiffness of the sheet S, based on the output of the reaction force measurer 53. The controller 60 may not only control the stiffness measurement device 50 but also control the entire image forming system 1, for example. [Operation of Stiffness Measurement Device]

Operations of the stiffness measurement device 50 in measuring the stiffness are described.

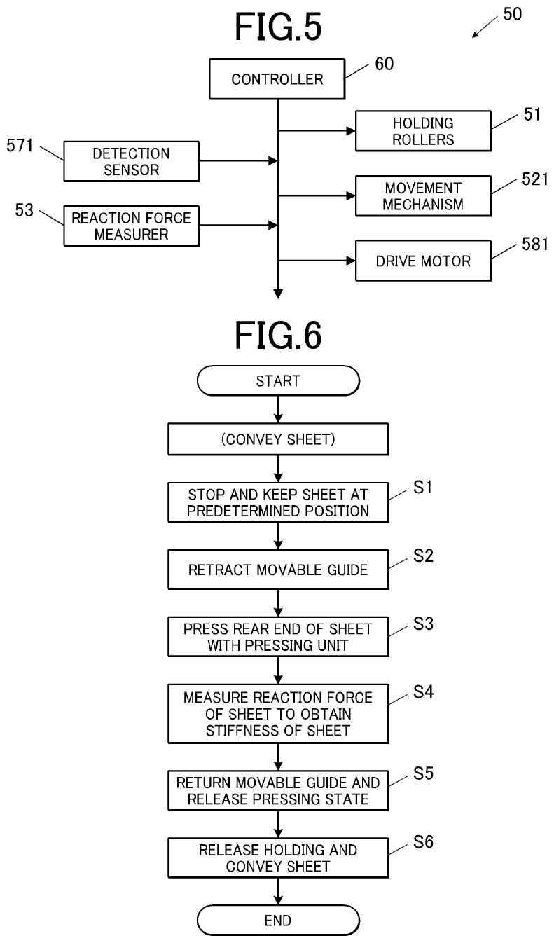

FIG. 6 is a flowchart illustrating a flow of operations of the stiffness measurement device 50 in measuring the stiffness. FIG. 7 to FIG. 9 are diagrams for explaining the operations of the stiffness measurement device 50.

Herein, the stiffness of the being-conveyed sheet S is measured in accordance with an execution command from the controller 60, for example.

As shown in FIG. 6, in measuring the stiffness, the controller 60 firstly stops and holds the being-conveyed sheet S at a predetermined position with the holding rollers 51, based on the output of the detection sensor 571 (step S1 in FIG. 7).

Specifically, the controller 60 stops conveying the sheet S and causes the holding rollers 51 to hold the sheet S after a lapse of a predetermined time since the sensor 571 detected passage of the rear end of the sheet S. Accordingly, the sheet S is held at a predetermined stiffness measurement position where the rear end of the sheet S is separate from the nip part of the holding rollers 51 by the distance L3 in the up-down direction.

Herein, the distance L3 in the up-down direction is shorter than the up-down direction distance L1 between the upper end of the second fixed guide 57 and the nip part of the holding rollers 51. That is, the upper end of the second fixed guide 57 is positioned at the upstream side in the conveyance direction D1 of the rear end of the sheet S held by the holding rollers 51. Therefore, when the pressing unit 52 presses the sheet S in the step S3 described later, it is possible to prevent the contact between the bent sheet S and the second fixed guide 57. Accordingly, the stiffness can be accurately measured. The distance between the rear end of the sheet S and the upper end of the second fixed guide 57 in the up-down direction (i.e., L1-L3) is determined to secure a predetermined distance, based on accuracy of stopping the sheet S, dimensional tolerances of the components, and so forth.

The distance L3 is shorter than the up-down direction distance L2 between the lower end of the movable guide 58 and the nip part of the holding rollers 51. That is, the lower end of the movable guide 58 is positioned at the upstream side in the conveyance direction D1 of the rear end of the sheet S held by the holding rollers 51. Therefore, a gap between the lower end of the movable guide 58 and the second fixed guide 57 positioned below the movable guide 58 can be narrowed. Accordingly, occurrence of sheet jam by the sheet S entering into the gap can be prevented.

Next, the controller 60 drives the drive motor 581 to retract the movable guide 58 from the position where the movable guide 58 faces the pressing unit 52 with the conveyance route R in-between (step S2, FIG. 8). In the present embodiment, the movable guide 58 is moved to the other side in the Y direction and thereby separated from the sheet S (the conveyance route R).

At this time, the movement amount of the movable guide 58 in the Y direction is greater than the amount of pressing of the pressing unit 52 (distance L4) in step S3 by a predetermined amount (e.g., 10 mm), as described later.

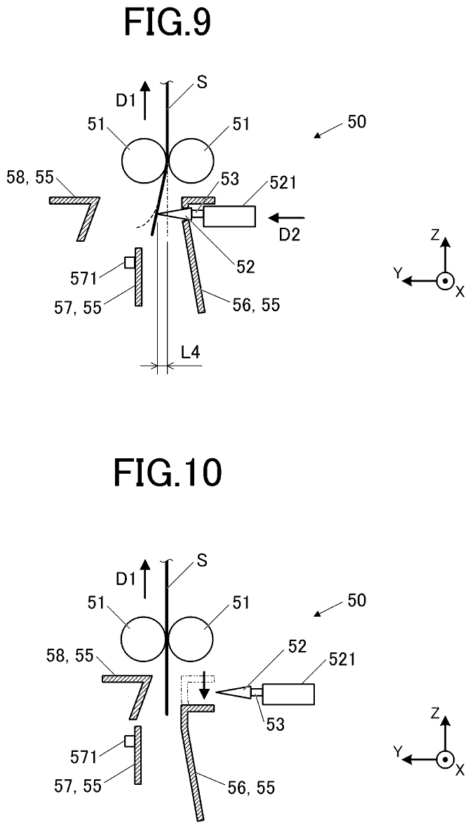

Next, the controller 60 drives the movement mechanism 521 to move the pressing unit 52 in the pressing direction D2 to press the rear end of the sheet S (step S3, FIG. 9). Accordingly, the rear end of the sheet S is pressed and bent toward the other side in the Y direction with the nip part of the holding rollers 51 as a base end.

For example, based on the output of the reaction force measurer 53, the controller 60 detects the position at which the tip of the pressing unit 52 starts contacting the main surface of the sheet S and determines this position as the reference position of the pressing unit 52. The controller 60 moves the pressing unit 52 to the other side in the Y direction by a predetermined distance L4 (e.g., several millimeters) from the reference position. Thus, the pressing unit 52 presses the rear end of the sheet S and bends the sheet S.

Herein, as described above, the movement amount (retraction amount) of the movable guide 58 in the Y direction in step S2 is greater than the pressing amount (distance L4) of the pressing unit 52 by a predetermined amount. Therefore, even if the sheet S warps as shown with a broken line in FIG. 9, for example, the contact between the bent sheet S and the movable guide 58 can be prevented. Thus, the stiffness can be accurately measured.

Next, the controller 60 measures the reaction force that the pressing unit 52 receives from the sheet S, and based on the measured reaction force, obtains the stiffness of the sheet S (step S4).

Specifically, the controller 60 obtains, from the reaction force measurer 53, the reaction force that the pressing unit 52 receives from the sheet S, and obtains the reaction force (pressing force) as the stiffness of the sheet S.

Next, the controller 60 returns the movable guide 58 to the normal position, where the movable guide 58 was disposed before the retraction, and releases the pressing state in which the pressing unit 52 presses the sheet S (step S5).

Specifically, the controller 60 first drives the drive motor 581 to move the movable guide 58 toward one side in the Y direction so that the movable guide 58 returns to the normal position, at which the movable guide 58 guides the sheet S to the holding rollers 51 (the position of FIG. 2). The controller 60 also drives the movement mechanism 521 to move the pressing unit 52 in the Y direction so that the pressing unit 52 returns to the normal position (the position of FIG. 2) on the one side in the Y direction relative to the conveyance route R. Thus, the pressing state in which the pressing unit 52 presses the sheet S is released.

Next, the controller 60 causes the holding rollers 51 to release the sheet S, conveys the sheet S with the conveyance rollers 25, and ejects the sheet S from the second ejection port 23 (step S6).

Thus, the stiffness measurement of the sheet S ends. The obtained stiffness of the sheet S is used for setting control parameters related to image formation. The setting of the control parameters may be executed according to the parameter setting process described in Japanese Unexamined Patent Publication No. 2024-019982, for example.

### Technical Effects of the Present Embodiment

As described above, according to the present embodiment, the guides 55 that guide the sheet S (sheet material) to the holding rollers 51 include the movable guide 58. The movable guide 58 is disposed at a position where the movable guide 58 faces the pressing unit 52 with the conveyance route R of the sheet S in-between. The movable guide 58 is retractable from the position.

Therefore, in a normal state where the stiffness measurement is not performed, the movable guide 58 is disposed to face the pressing unit 52 and can guide the sheet S. On the other hand, in measuring the stiffness, the movable guide 58 is retracted from the position where the movable guide 58 faces the pressing unit 52, so that the pressing unit 52 can press the sheet S. Thus, it is possible to prevent the contact between the guides 55 and the pressing unit 52 (or the sheet S) without forming a large gap in the guides 55. Accordingly, a decrease in the conveyance performance of the sheet S can be suppressed, and the stiffness of the sheet S can be appropriately measured.

Further, according to the present embodiment, the second fixed guide 57 is disposed at the upstream side of the sheet S held by the holding rollers 51 in the conveyance direction D1 and is separate from the sheet S by a predetermined distance in the conveyance direction D1.

Thus, when the pressing unit 52 presses the sheet S in the Y direction, the pressed and bent sheet S can be prevented from contacting the second fixed guide 57. Accordingly, the stiffness can be accurately measured.

Further, according to the present embodiment, the upstream end (lower end) of the movable guide 58 in the conveyance direction D1 is at the upstream side in the conveyance direction D1 of the sheet S held by the holding rollers 51.

Therefore, the gap between the lower end of the movable guide 58 and the second fixed guide 57 below the movable guide 58 can be narrowed. Accordingly, a sheet jam by the sheet S entering into the gap can be prevented.

Further, according to the present embodiment, the guides 55 guide the sheet S to the holding rollers 51 along the vertical direction, and the pressing unit 52 presses the sheet S in a direction perpendicular to the vertical direction.

Thus, the effect of gravity in pressing the sheet S can be minimized, and the stiffness can be accurately measured.

Further, according to the present embodiment, the first fixed guide 56 has the through hole 56a in the guide surface that guides the sheet S. The through hole 56a corresponds to the shape of the pressing unit 52. In pressing the sheet S, the pressing unit 52 protrudes from the through hole 56a of the first fixed guide 56.

Thus, in the space around the pressing unit 52, the first fixed guide 56 can suitably guide the sheet S.

Further, according to the through hole 56a of the first fixed guide 56 in the present embodiment, the downstream opening end in the conveyance direction D1 may be farther from the conveyance route R than the upstream opening end.

Thus, it is possible to prevent the being-conveyed sheet S from entering the through hole 56a.

Further, according to the present embodiment, after the holding roller 51 holds the sheet S and before the pressing unit 52 presses the sheet S, the movable guide 58 is moved in the same direction as the pressing direction D2 by a movement amount greater than the pressing amount of the pressing unit 52 (the distance L4).

Thus, even when the sheet S is warped, for example, the contact between the warped sheet S and the movable guide 58 can be prevented. Accordingly, the stiffness can be accurately measured.

Further, according to the present embodiment, the detection sensor 571 capable of detecting the position of the sheet S is fixed to the second fixed guide 57 (or the first fixed guide 56).

Therefore, the position of the detection sensor 571 can be fixed, unlike the case where the detection sensor 571 is arranged on the movable guide 58. Thus, it is possible to suppress a decrease in accuracy of position control of the sheet S, based on the output of the detection sensor 571.

### Others

Although an embodiment of the present disclosure has been described, embodiments to which the present disclosure is applicable are not limited to the above embodiment or its modification examples. The embodiment can be appropriately modified without departing from the scope of the present disclosure.

For example, in the above embodiment, the pressing unit 52 protrudes and retracts from the through hole 56a formed in the first fixed guide 56. For another example, instead of forming the through hole in the first fixed guide 56, the first fixed guide 56 may be retractable from the movement range of the pressing unit 52, as illustrated in FIG. 10. Thus, it is possible to prevent a sheet jam by the sheet S entering into the through hole 56a.

Although the conveyance direction D1 of the sheet S is along the vertical direction in the above embodiment, the conveyance direction according to the present disclosure may not be along the vertical direction.

Although the stiffness measurement device 50 is installed in the sheet conveyance device 20 in the above embodiment, the position of the stiffness measurement device in the image forming system is not particularly limited. For example, the stiffness measurement device 50 may be installed in the image forming apparatus.

Although the embodiment of the present invention has been described and illustrated in detail, the disclosed embodiment is made for purposes of illustration and example only and not limitation. The scope of the present invention should be interpreted by terms of the appended claims.

What is claimed is:

1. A stiffness measurement device comprising:
a holder that is capable of stopping a sheet material being conveyed along a conveyance direction and holding the sheet material;
a pressing unit that is disposed upstream of the holder in the conveyance direction and that presses the sheet material held by the holder from one main surface side of the sheet material;
a stiffness obtainer that measures reaction force of the sheet pressed by the pressing unit to obtain stiffness of the sheet; and
a guide that is disposed upstream of the holder in the conveyance direction and guides the sheet material to the holder, wherein:
the guide includes a movable guide, and
the movable guide is disposed at a position where the movable guide faces the pressing unit with a conveyance route of the sheet material in-between and is retractable from the position.

2. The stiffness measurement device according to claim 1, wherein the guide includes:
a first fixed guide that is fixed at the one main surface side with respect to the conveyance route and
a second fixed guide that is fixed at another main surface side of the sheet material with respect to the conveyance route.

3. The stiffness measurement device according to claim 2, wherein the second fixed guide is disposed upstream of the sheet material held by the holder in the conveyance direction and is separated from the sheet material by a predetermined distance in the conveyance direction.

4. The stiffness measurement device according to claim 1, wherein an upstream end of the movable guide in the conveyance direction is disposed upstream of the sheet material held by the holder in the conveyance direction.

5. The stiffness measurement device according to claim 1, wherein:
the guide guides the sheet material such that the sheet material enters the holder along a vertical direction, and
the pressing unit presses the sheet material in a direction perpendicular to the vertical direction.

6. The stiffness measurement device according to claim 2, wherein:
a guide surface of the first fixed guide for guiding the sheet material has a through hole corresponding to a shape of the pressing unit, and
in pressing the sheet material, the pressing unit protrudes from the through hole of the first fixed guide.

7. The stiffness measurement device according to claim 6, wherein a downstream opening end of the through hole of the first fixed guide in the conveyance direction is farther from the conveyance route than an upstream opening end of the through hole in the conveyance direction.

8. The stiffness measurement device according to claim 1, wherein after the holder holds the sheet material and before the pressing unit presses the sheet material in a pressing direction, the movable guide is moved in a direction identical to the pressing direction by a movement amount greater than a pressing amount by the pressing unit.

9. The stiffness measurement device according to claim 2, further comprising a detection sensor fixed to the first fixed guide or the second fixed guide and capable of detecting a position of the sheet material.
